(19) United States
(12) Patent Application Publication
(10) Pub. No.: US 2018/0325018 A1
(43) Pub. Date: Nov. 15, 2018

(54) Flora Transplanting Device and Method

(71) Applicant: Kenneth Walker, JR., St. San Mateo, CA (US)

(72) Inventor: Kenneth Walker, JR., St. San Mateo, CA (US)

(21) Appl. No.: 15/594,828

(22) Filed: May 15, 2017

(51) Int. Cl. A01C 11/00; A01C 5/04; A01C 5/02

(52) U.S. Cl. CPC A01C 11/006; A01C 14/00; A01C 5/02; A01C 5/04

(57) ABSTRACT

A device for facilitating the transplantation of a potted plant. The flora transplanting device includes a container having an open upper end, open lower end, and an intermediate surrounding side wall therebetween. The lower end can puncture a soil surface, allowing the flora transplanting device to be inserted into the soil by pressing on the upper end. The lower end is serrated to facilitate insertion of the device into the soil. Graduation marks are present on the outside of the surrounding side wall of the device to indicate insertion depth. In operation, the soil circumscribed by the device is removed and a plant is placed therein. The flora transplanting device supports the surrounding soil while the plant is inserted into the device to ease the process of planting. In some embodiments, the upper end of the device forms a handle to ease removal of the device from the soil.

### BACKGROUND OF THE INVENTION

The present invention relates to a gardening tool. Specifically, the present invention provides a hollow container having depth indication marks on a side wall and a lower end designed to puncture the surface of soil.

Transplanting smaller plants into a bigger pot or into the ground is a difficult and physically demanding task, especially determining and excavating a hole with the proper depth and diameter in which to plant. Once a hole with the proper parameters is established, an individual must take precautions to prevent the hole from backfilling.

Without appropriate tools to complete the transplanting process, the individual can cause severe damage to the plant's roots. Damage to the plant will cause the plant to go into shock, stalling growth and causing potential death of the plant. The present invention comprises a device that assists in the transfer of potted plants without shocking the plant, thereby allowing the plant to take root in a new pot quickly without causing damage to the plant.

Several devices have been proposed to aid in the transplant of flora. One strategy is to plant flora within a transplant container, the transplant container having a removable bottom or sides. This strategy may prevent the plant from experiencing shock by protecting the roots, but does not aid in determining the parameters of the hole in which to plant the flora.

Most of the known strategies for transplanting potted flora focus on preserving the structural integrity of the subterraneous organs of the flora. These solutions fail to recognize that providing the appropriate size hole in which to place the flora also helps maintain the structural integrity of the subterraneous organs by minimizing the risk of subterraneous organ exposure to air and sunlight or compression of the subterraneous organs against the ground. Thus, a device that indicates depth and prevents backfill into the hole would be desirable to a person who is transplanting flora.

### SUMMARY OF THE INVENTION

In view of the foregoing disadvantages inherent in the known types of flora transplanting devices now present in the prior art, the present invention provides a device and method for achieving proper hole depth and maintaining that depth by preventing backfill into the hole, wherein the same can be utilized for providing convenience for the user when excavating a hole to receive the intended transplanted flora. The present transplanting device comprises a container having open upper and lower ends with a side wall positioned therebetween, resulting in the interior of the container being hollow. The side wall of the container has both an outside surface and an inside surface. The outside surface having graduation marks thereon. The graduation marks provide an indication of depth. In some embodiments, the lower end of the container is serrated. The upper end of the container comprises a pair of handles which form finger holds between the handles and the upper end of the container. The transplanting device provides a convenient way to ensure proper hole depth and prevent backfill from entering the hole.

One object of the present invention is to provide a flora transplanting device that enables a user to excavate the proper sized hole in which to plant flora, wherein the user can determine the depth of the hole by inserting the flora transplanting device into the soil until the soil surface becomes flush with a certain point indicated by graduation marks on the outside surface of the container.

Another object of the present invention is to provide a method to preserve proper hole depth by preventing soil excavated by a gardener from falling back into the excavated area.

Yet another object of the present invention is to provide a hand-held gardening tool that can be easily manually inserted into the soil surface.

Another object of the invention is to provide a gardening tool and method to minimize damage to the subterraneous organs of a transplanted flora by mitigating the risk of subterraneous organ compression against the ground and exposure of subterraneous organs on the soil surface with a properly sized hole in which to transplant the flora.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the front of an embodiment of the flora transplanting device.

FIG. 2 shows a perspective view of the front of an embodiment of the flora transplanting device in use.

FIG. 3 shows a cross-sectional view of an embodiment of the flora transplanting device in use.

### DETAILED DESCRIPTION OF THE INVENTION

Reference is made herein to the attached drawings. Like reference numerals are used throughout the drawings to depict like or similar elements of the flora transplanting device. The figures are intended for representative purposes only and should not be considered to be limiting in any respect. Unless specifically limited to a single unit, “a” is intended to be equivalent to “one or more” throughout the present disclosure.

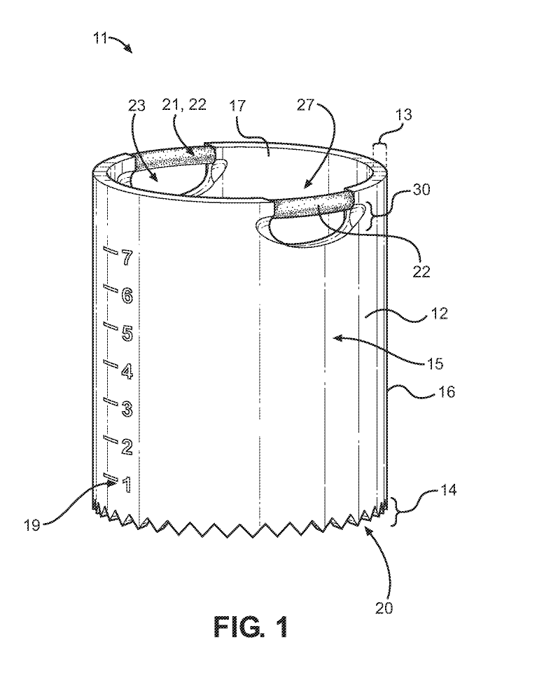

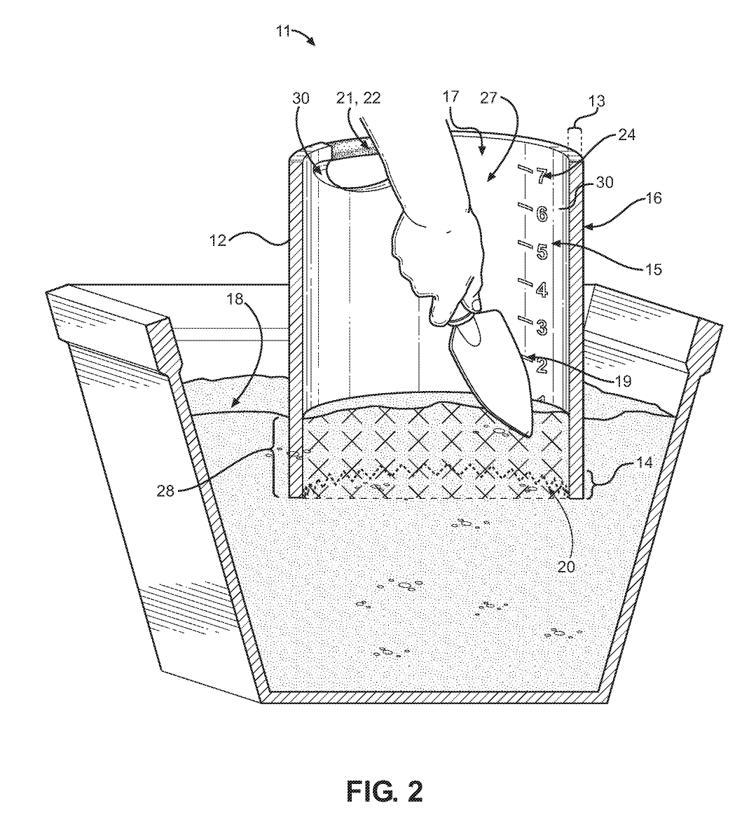

Referring now to FIGS. 1 and 2, there is shown a perspective view of the front of an embodiment of the flora transplanting device and perspective view of the front of an embodiment of the flora transplanting device in use. The flora transplanting device 11 comprises a container 12 having an open upper end 13, an open lower end 14 and a side wall 15 therebetween. The side wall has an outside surface 16 and an inside surface 17. The inside surface 17 circumscribes the interior volume 27 of the container. The interior volume 27 of the container 12 is hollow so a predetermined volume of soil 28 can be contained by the inside surface 17 of the container. In the illustrated embodiment, the container 12 is comprises a cylindrical shape, thereby providing a container that can be easily inserted into the ground and the insertion potentially aided by a twisting motion. In the illustrated embodiments, the outside surface 16 has graduation marks 19 disposed thereon, thereby providing a means to measure the depth the container has been into the soil surface. In other embodiments, the graduation marks 19 are disposed upon the inside surface 17. In some embodiments, the graduation marks 19 are distance measurement values 24, such as inches or centimeters, with the lowest value positioned closest to the lower end 14 and each mark sequentially increasing therefrom with the highest value positioned closest to the upper end 13.

In the illustrated embodiment, the lower end 14 of the container 12 is a serrated edge 20, whereby the user can press on the upper end 13 of the container 12 and rotate the container 12 to force the flora transplanting device 11 through a soil surface 18. In this embodiment, the serrations are triangular in shape. Additionally, in the illustrated embodiment, the serrated edge 20 extends the entire perimeter of the lower end 14.

Further, in the illustrated embodiment, the upper edge 13 possesses a pair of handles 21. The handles 21 can be a pair of rubber grips 22 affixed to the upper edge 13. In the illustrated embodiment, the handles 21 are sequestered over depressions 31 in the upper edge to form finger holds 23. The arrangement of the handles 21 to form finger holds 23 allows a user of the flora transplanting device 11 to remove the flora transplanting device from the ground by inserting their fingers into the finger holds 23 and pulling up on the handles 21. The container 12 can be composed of any suitable material, such as plastic, metal or rubber. In one embodiment, the flora transplanting device 11 measures approximately 10″ in length and 6.5″ in width. However, exact measurement, construction and size may vary upon manufacturing.

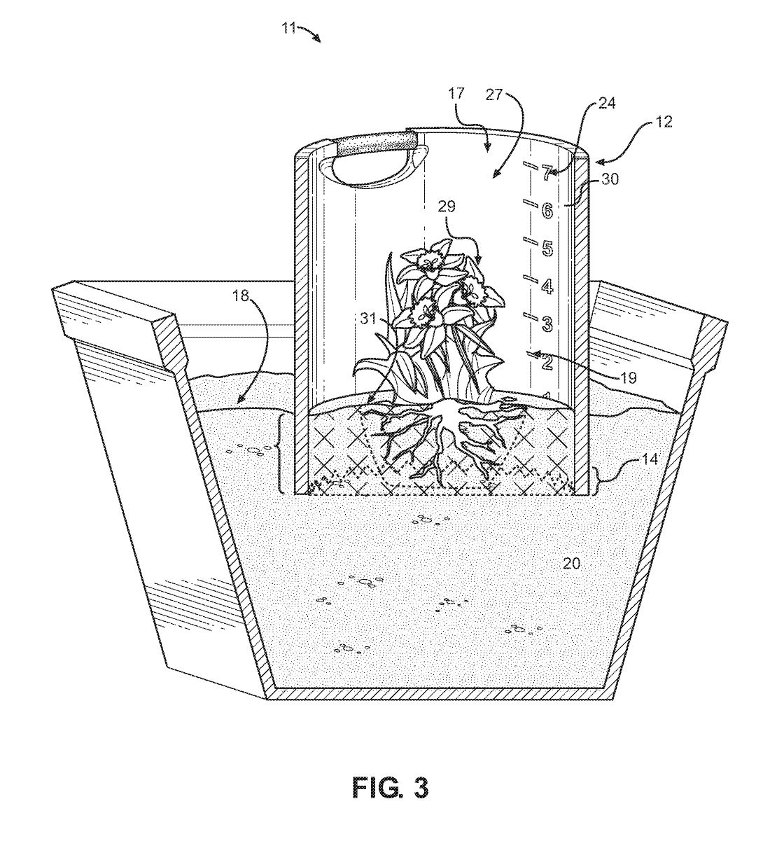

Referring now to FIG. 3, there is shown a cross-sectional view of an embodiment of the flora transplanting device in use. The predetermined volume of soil 28 contained by the inside surface 17 of the container, can be calculated by the size of the subterraneous organs 31 of the flora 29.

In operation, the flora transplanting device 11 is pressed into soil by applying force to the upper edge of the container 12, specifically, by grasping and pushing down on the handles 21 positioned on the upper edge of the container. The graduation marks 19 along the side wall 15 of the container 12 are used to measure the depth at which the flora transplanting device 11 is inserted into the soil. Specifically, depth is measured by aligning the soil surface 18 with a graduation mark 19. The depth of the flora transplanting device 11 can be determined by the depth of the subterraneous organs 31 of the transplanted flora 29. After a desired depth is reached, the soil within the interior volume 28 of the flora transplanting device 11 is excavated. The mode of excavation can vary, e.g. by hand or a handheld shovel.

Once the soil within the interior volume 28 of the flora transplanting device 11 is removed, the side wall 15 of the flora transplanting device 11 supports the surrounding soil. While the flora transplanting device 11 supports the surrounding soil, the user can insert the flora root-first into the interior volume 27 of the flora transplanting device 1. The graduation marks 19 guide the user to the proper placement depth for the transplanted flora 29, so that no part of the subterraneous organs 31 of the transplanted flora 29 rest above the soil surface 18. Once the transplanted flora 29 is situated within the interior volume 27 of the flora transplanting device 11, the user can fill any remaining space between the subterraneous organs 31 of the flora and the inside surface 17 of the flora transplanting device 11.

The flora transplanting device 11 can then be removed, allowing the transplanted flora 29 to take hold in the new environment. A user can remove the flora transplanting device 11 by inserting their fingers into the fingerholds 23, grasping the handles 21 and pulling up on the handles 21. In some instances, a user may employ a rotary motion to the flora transplanting device 11 to aid in extraction of the flora transplanting device 11 from the soil.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A flora transplanting device, comprising:
A container having an open upper end, an open lower end, and a side wall therebetween;
the side wall having an outside surface and an inside surface;
the lower end configured to puncture a soil surface;
the container comprising at least one graduation marks thereon, wherein the graduation marks are configured to indicate depth.

2) The device of claim 1, wherein the lower end is serrated.

3) The device of claim 1, wherein the upper end comprises a handle.

4) The device of claim 3, wherein the handle comprises a pair of rubber grips, wherein the rubber grips form finger holds.

5) The device of claim 1, wherein the graduation marks comprise measurement values having the lowest measurement value positioned at the open lower end and the highest measurement value positioned at the open upper end.

6) The device of claim 1, wherein the graduation marks on disposed on the interior of the container.

7) The device of claim 1, wherein the graduation marks on disposed on the exterior of the container.

8) A method for transplantation of a plant, comprising:
providing a container having an open upper end, an open lower end, a side wall therebetween and an interior volume, the side wall having an outside surface and an inside surface, the lower end configured to puncture a soil surface, the outside surface having an at least one graduation marks thereon, wherein the graduation marks are configured to indicate depth.
inserting the open lower end into the soil surface to a desired depth by pressing on the open upper end;
using the graduation marks to measure the depth the container is inserted into the soil surface;
excavating the soil within the interior volume of the container;
placing a plant within the excavated area through the interior volume of the container;
removing the container from the soil;
placing soil into a cavity left by the removal of the container.
